(19) United States
(12) Patent Application Publication
(10) Pub. No.: US 2023/0035638 A1
(43) Pub. Date: Feb. 2, 2023

(54) DISHWASHER HAVING A HEAT EXCHANGER

(71) Applicant: WHIRLPOOL CORPORATION, BENTON HARBOR, MI (US)

(72) Inventors: ALVARO VALLEJO, SAINT JOSEPH, MI (US); SUBHASH N. VARVATE, MAHARASHTRA (IN); MATEUSZ MICHAL WOLOWICZ, Lower Silesian District (PL)

(21) Appl. No.: 17/965,913

(22) Filed: Oct. 14, 2022

Related U.S. Application Data
(63) Continuation of application No. 16/657,044, filed on Oct. 18, 2019.

(30) Foreign Application Priority Data
Oct. 18, 2018 (EP) 182013680

(51) Int. Cl. A47L 15/42; A47L 15/48

(52) U.S. Cl. CPC A47L 15/4291; A47L 15/4217; A47L 15/4223; A47L 15/48; A47L 2501/01; A47L 2501/02; A47L 2501/06

(57) ABSTRACT

A dishwashing machine comprising a tub, a sump, a first water tank, a second water tank and a heat exchanger. The sump is fluidly coupled to the tub. The first water tank is directly fluidly coupled to a water supply external the dishwashing machine and having a fresh water. The second water tank includes a singular inlet that is selectively fluidly coupled to the first water tank through the sump. The heat exchanger is located inside the first water tank.

### CROSS REFERENCE TO RELATED APPLICATIONS

This application is a continuation of U.S. patent application Ser. No. 16/657,044, filed Oct. 18, 2019, which claims priority to European Patent Application No. 18201368, filed on Oct. 18, 2018, both which are incorporated herein by reference.

### TECHNICAL FIELD OF THE INVENTION

The present invention generally relates to the field of dishwashing appliances and more particularly to dishwashers of the type having a heat exchanger allowing to recover thermal energy from hot waste water.

### BACKGROUND

It is known that energy consumption requirements of household appliances are becoming stricter and stricter, constantly leading manufacturers to look for improved solutions. In the case of dishwashing machines it is known to use hot water from a previous washing cycle phase as a heat exchange media to pre-heat fresh water stored in a tank or container and intended to be used for a subsequent washing cycle phase. In this way less thermal energy is needed to bring the fresh water to the temperature required to carry out the washing cycle, e.g. 65° C. DE3901169 gives an example of a dishwashing machine of this type.

### SUMMARY OF THE INVENTION

In one aspect, the present disclosure relates to dishwashing machine comprising a tub, a sump fluidly coupled to the tub, a first water tank being directly fluidly coupled to a water supply external the dishwashing machine and having a fresh water, with the first water tank being selectively fluidly coupled, via a first on-off valve, to the sump, a second water tank having a singular inlet that is selectively fluidly coupled to the first water tank through the sump, and a heat exchanger located inside the first water tank, the heat exchanger having a heat exchanger inlet selectively fluidly coupled to the sump, the heat exchanger being able to transfer a heat with the fresh water within the first water tank.

### BRIEF DESCRIPTION OF THE DRAWINGS

Reference will be made to the figures of the accompanying drawings, in which:

FIG. 1 is a diagram schematically showing the main components of a dishwashing machine according to an embodiment of the present invention;

FIG. 2 is a diagram schematically showing the main components of a dishwashing machine according to another embodiment of the present invention.

### DETAILED DESCRIPTION OF PREFERRED EMBODIMENTS

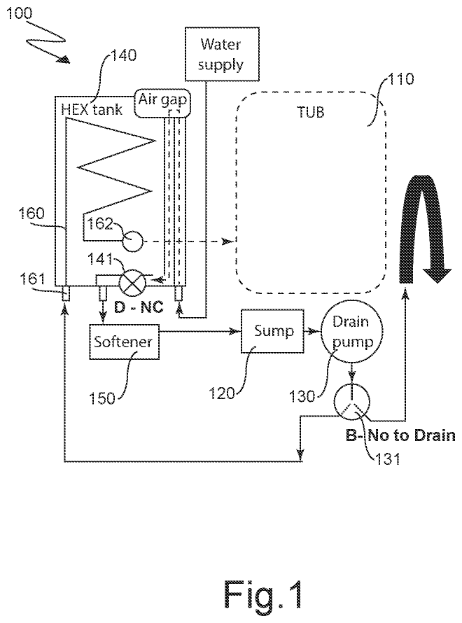

With reference initially to FIG. 1, a dishwashing machine according to the invention is generally indicated by reference number 100. The dishwashing machine 100 comprises a tub 110 that is disposed in an outer case (not shown) and defines a wash space where dishes can be received for washing. A sump 120 is fluidly connected to the tub 110 to receive the wash water needed to wash dishes and to collect the wash water to be recirculated during a wash cycle. As schematically shown in FIG. 1, the sump 120 may be arranged e.g. under the tub 110 it in a vertical direction so as to collect water by gravity.

A door (not shown) of the washing machine opens or closes the tub 110. The door may be equipped with a control panel and an associated control unit (not shown) that control operation of the dish washing machine 100.

The tub 110 houses a plurality of racks (not shown) where dishes can be placed for washing. The racks may comprise e.g. a top rack and a bottom rack disposed under the top rack.

The tub 110 also comprises a plurality of spray arms (not shown), which are supplied with wash water from the sump 120 and spray it towards the dishes arranged on the racks disposed inside the tub 110. To this aim a wash pump (not shown) is employed.

The spray arms may comprise e.g. a bottom arm (not shown) connected to the sump 120, an intermediate arm (not shown) disposed above the bottom arm and supplied with the wash water from the sump 120, and a top arm (not shown) disposed above the intermediate arm and supplied with the wash water from the sump 120.

It will be appreciated that the configuration of the door and of the racks and spray arms arranged in the tub are not limiting features of the invention.

A drain pump 130 is fluidly connected to the sump 120 to discharge the wash water at the end of a wash cycle.

The dishwashing machine 100 also comprises a water tank 140, i.e. a container or reservoir, configured to receive and store a predefined amount of fresh water from an external water supply, e.g. the water mains. The water tank 140 is fluidly connected to the sump 120 through an on-off valve 141 and a softener 150. At the beginning of a wash cycle, the on-off valve 141 is opened and the fresh water stored in the water tank 140 is made to pass through the softener 150 and collected into the sump 120, where it is heated and made to circulate to the spray arms. The on-off valve 141 is configured to allow either to store water in the tank 140 as discussed above, or to let it pass directly from the main water supply to the softener 150 as it happens in prior art dishwashing machines.

The dishwashing machine 100 according to the invention also comprises a heat exchanger 160 that is arranged inside the water tank 140. The heat exchanger 160 may for instance be integrally formed with the water tank 140, or it can be made as a separate component housed in the water tank 140.

The heat exchanger 160 has an inlet 161 fluidly connected with the drain pump 130 via a diverter valve 131 and a pipe, as well as through an outlet 162 that is fluidly connected to the tub 110.

At the end of a wash cycle phase the diverter valve 131 connected to the drain pump 130 allows to selectively supply the hot waste water collected in the sump 120 to the heat exchanger 160 so as to warm fresh water stored in the water tank 140. For instance, the cycle phase can be the main wash phase, wherein a detergent is dispensed into the tub.

Hot waste water enters the heat exchanger 160 at the inlet 161 and is discharged through the outlet 162 back into the tub 110, from which it reaches the sump 120 and may be made to recirculate into the heat exchanger 160. The thermal energy of the hot waste water collected in the sump 120 at the end of a wash cycle can thus be transferred to the fresh water stored in the water tank 140 before the waste water is discharged from the dishwashing machine by the drain pump. To this aim, the diverter valve 131 is set in fluid communication with an external discharge pipe, thus interrupting fluid communication with the heat exchanger 160.

In other words, according to the invention hot waste water, which is drained out of a prior art dishwashing machine, is instead effectively used at the end of a wash cycle phase in order to recover thermal energy to heat the fresh water stored in the water tank 140. A subsequent washing cycle phase will therefore benefit from pre-heated water, whose temperature is the ambient temperature or higher, thus requiring a lower amount of thermal energy to reach a desired temperature. For example, hot water having a temperature of about 50° C. is typically required in the rinsing phase. By making hot waste water, which has a temperature of about 45° C., to flow through the tank 140 the thermal energy needed to heat fresh rinsing water stored therein is much lower than the energy that would be required to heat it directly from the water supply. Energy consumption is therefore effectively reduced.

The diverter valve 131 is automatically controlled by the control unit of the dishwashing machine 100.

The arrows in FIG. 1 schematically show the path of the water flow in the different parts of the dishwashing machine 100, in particular from the drain pump 130 to the heat exchanger 160 and the tub 110, as well as from the tank 140 to the softener 150 and to the sump 120.

Thanks to the relatively short flow path from the drain pump 130 to the fresh water tank 140 compared to the typical length of the flow path between the same tank and the wash pump of a dishwashing machine, losses of thermal energy from the hot waste water are minimized, thus improving efficiency of the heat recovery process. For the same reason, the flow rate of the hot waste water made to circulate through the heat exchanger 160 is more accurate and stable, which allows to achieve a very good performance during the heat exchange process.

Moreover, the electric motor driving the drain pump 130 may advantageously be smaller than the motor of the wash pump, which contributes to increase energy savings during operation of the dishwashing machine. The drain pump 130 preferably has a variable speed motor, which provides the further advantage of a low noise during operation.

During a typical wash cycle phase, fresh water stored in the water tank 140 is fed to the sump 120 via the softener 150 and used for a pre-wash step. No soap is generally used in this phase. The water tank 140 is then refilled from the external water supply.

The water used for the pre-wash step is drained by the drain pump 130 and the fresh water stored in the tank is filled to the sump 120, heated to a desired temperature, e.g. 65° C., and used to carry out the main wash cycle together with a measured amount of soap stored in a suitable reservoir of the dishwashing machine 100.

According to the invention, at the end of the heated main wash phase, fresh water is filled into the water tank 140 and the hot waste water collected in the sump 120 is made to circulate through the heat exchanger 160 by the drain pump 130 so as to recover thermal energy and heat the fresh water stored in the tank 140. As discussed above, the diverter valve 131 associated with the drain pump 130 is set in fluid communication with the heat exchanger 160. After this process the diverter valve 131 is set in fluid communication with a discharge pipe and the waste water is drained out.

The water tank 140 can further be used to store water from the very last rinse phase and use it in the pre-wash phase of the following wash cycle.

A subsequent wash cycle phase will therefore benefit from pre-heated water stored in the water tank 140. It will be appreciated that the pre-heated water is at room temperature or higher depending on the time that lapses between a wash cycle and a subsequent one.

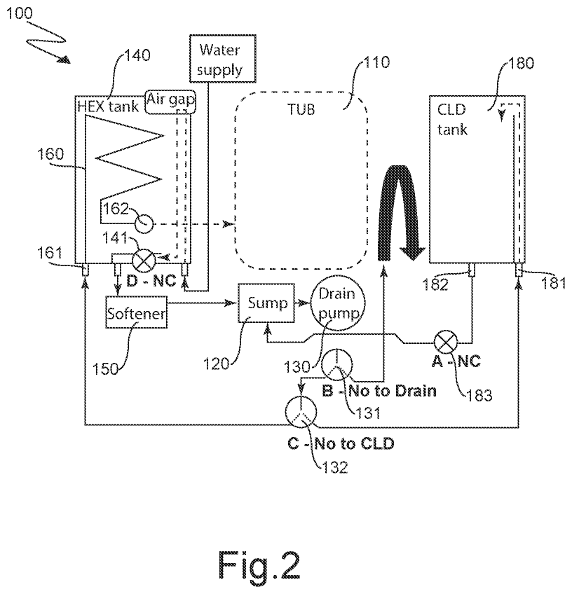

Now referring to FIG. 2, according to another embodiment of the invention the drain pump 130 may advantageously be fluidly connected not only to the heat exchanger 160, but also to a closed-loop drying assembly of the dishwashing machine 100. Such an assembly is typically employed to remove moisture from hot air used to dry dishes after a wash cycle. The closed-loop drying assembly of the dishwashing machine 100 of the invention comprises in a known way a water tank 180 having an inlet 181 and an outlet 182 allowing to fill in and discharge water, respectively. According to the invention, the inlet 181 is fluidly connected to the drain pump 130, thereby allowing to use this pump to feed fresh water received in the sump 120 through the external water supply and the softener 150 to the water tank 180.

This results in further energy savings in view of the small power motor employed by the drain pump compared to the motor of the wash pump.

As shown in the embodiment of FIG. 2, the drain pump 130 is fluidly connected to the water tank 180 of the closed-loop drying assembly by way of a first diverter valve 131, which is the same valve described above in connection with the previous embodiment of the invention, and by way of a second diverter valve 132 arranged downstream of the first diverter valve 131 and connected in series with it. Both valves are automatically driven by the control unit of the dishwashing machine 100. According to this configuration, the first diverter valve 131 is configured to establish fluid communication with either the second diverter valve 132 or the external discharge pipe, while the second diverter valve is configured to establish fluid communication with either the heat exchanger 160 or the tank 180 of the closed-loop drying assembly.

The arrows in FIG. 2 schematically show the path of the water flow in the different parts of the dishwashing machine 100, in particular from the drain pump 130 to the heat exchanger 160 and the tub 110, as well as from the tank 140 to the softener 150 and to the sump 120. The water flow path to the water tank 180 of the closed-loop drying assembly is also schematically shown.

It will be appreciated that a single three-way valve might be used instead of the first and second diverter valves described above.

Considering that the fresh water stored in the water tank 180 and used to cool the condenser during the drying cycle is at least at room temperature, an additional water amount is available to be fed to the sump 120 and employed in a wash cycle together with the water stored in the water tank 140 associated with the heat exchanger 160. To this aim an on-off valve 183 may be arranged downstream of the outlet 182 and connected in series with the water tank 180 of the closed-loop drying assembly.

According to this configuration the water stored in the water tank 140 having the heat exchanger 160 may be used e.g. for a pre-wash step. As discussed above, this water is at least at room temperature. The fresh and clean water stored in the water tank 180 of the closed-loop drying assembly, which is also at least at room temperature, can be used for the main wash step. After the main wash step the resulting hot waste water can be fed to the heat exchanger 160 and used to warm fresh water newly fed from the water supply into the water tank 140, which may in turn be used for a final rinse step.

The present invention has hereto been disclosed with reference to preferred embodiments thereof. It will be appreciated that there may be other embodiments relating to the same inventive idea, all of which are included in the scope of protection defined by the claims set out below.

What is claimed is:

1. A dishwashing machine comprising:
a tub;
a sump fluidly coupled to the tub;
a first water tank being directly fluidly coupled to a water supply external the dishwashing machine and having a fresh water, with the first water tank being selectively fluidly coupled, via a first on-off valve, to the sump;
a second water tank having a singular inlet that is selectively fluidly coupled to the first water tank through the sump; and
a heat exchanger located inside the first water tank, the heat exchanger having a heat exchanger inlet selectively fluidly coupled to the sump, the heat exchanger being able to transfer a heat with the fresh water within the first water tank.

2. The dishwashing machine of claim 1, wherein the second water tank includes an outlet selectively fluidly coupled, via a second on-off valve, to the sump.

3. The dishwashing machine of claim 1, further comprising:
a discharge pipe that is used to exhaust at least a portion of a fluid from the sump from the dishwashing machine; and
at least one diverter valve fluidly coupling the sump to at least one of the discharge pipe, the heat exchanger inlet or the singular inlet of the second water tank.

4. The dishwashing machine of claim 3, wherein the at least one diverter valve comprises a first diverter valve and a second diverter valve arranged downstream of the first diverter valve, with the first diverter valve selectively fluidly coupling the sump to at least one of the second diverter valve or the discharger pipe and the second diverter valve selectively fluidly coupling the first diverter valve to at least one of either the singular inlet or the heat exchanger inlet.

5. The dishwashing machine of claim 1, wherein the dishwashing machine operates according to a wash cycle including, at least:
a pre-wash step where water is supplied to the first water tank, via the water supply, and then to the tub through the sump;
a main wash step where water stored in the second water tank is supplied to the tub through the sump; and
a final rinse step where a hot waste water from the sump is fed to the heat exchanger for warming a water stored within the first water tank, and where the water within the first water tank is fed to the tub through the sump.

6. The dishwashing machine of claim 5, wherein at least a portion of the fresh water from the first water tank is fed to the second water tank prior to the main wash step.

7. The dishwashing machine of claim 1, wherein the second water tank is able to receive at least a portion of the fresh water from the first water tank through the sump.

8. The dishwashing machine of claim 1, wherein the dishwashing machine is configured to perform a wash cycle comprising:
selectively supplying at least a portion of the fresh water stored in the first water tank to the tub for a pre-wash phase;
selectively supplying a second water stored in the second water tank to the tub for a main wash phase; and
selectively supplying a third water from the tub to the heat exchanger inlet, the third water having a first temperature higher than the temperature of the fresh water within the first water tank;
heating the fresh water via the third water to define a heated fresh water; and
selectively supplying the heat fresh water to the tub for a final rinse phase;
wherein the pre-wash phase occurs prior to the main wash phase, which occurs prior to the final rinse phase.

9. The dishwashing machine of claim 8, wherein the fresh water and the second water are stored within the first water tank and the second water tank, respectively, prior to the pre-wash phase.

10. The dishwashing machine of claim 1, further comprising an outer case defining an interior, with the tub being provided within the interior.

11. The dishwashing machine of claim 10, wherein the first water tank and the second water tank are provided within the interior.

12. The dishwashing machine of claim 1, wherein during a wash cycle of the dishwashing machine, a flow of water from both the first water tank and the second water tank is fed through the sump and into the tub.

13. The dishwashing machine of claim 1, further comprising a drain pump fluidly coupled to the sump.

14. The dishwashing machine of claim 13, wherein the drain pump is able to pump at least a portion of the fresh water from the first water tank through the sump and into the second water tank.

15. The dishwashing machine of claim 14, wherein the drain pump is able to pump a waste water from the tub from the sump.

16. The dishwashing machine of claim 1, further comprising a condenser located inside the second water tank and wherein at least a portion of the fresh water in the first water tank is fed to the second water tank to cool the condenser within the second water tank.

17. The dishwashing machine of claim 1, wherein the first water tank, the second water tank and the heat exchanger form a closed-loop drying system of the dishwashing machine.

18. The dishwashing machine of claim 1, wherein the heat exchanger includes a heat exchanger outlet fluidly coupled to the tub.

19. The dishwashing machine of claim 18, wherein the heat exchanger receives a waste water from the sump.

20. The dishwashing machine of claim 19, wherein at least a portion of the waste water within the heat exchanger is fed back into the tub and into the sump where it is then recirculated back into the heat exchanger.
